(19) United States
(12) Patent Application Publication
(10) Pub. No.: US 2019/0285532 A1
(43) Pub. Date: Sep. 19, 2019

(54) A PARTICLE SIZE SENSOR FOR METALLIC POWDERS

(71) Applicant: RENISHAW PLC, Wotton-under-Edge, Gloucestershire (GB)

(72) Inventors: Adrian PORCH, Pontypridd (GB); Nicholas CLARK, Didcot (GB)

(73) Assignee: RENISHAW PLC, Wotton-under-Edge, Gloucestershire (GB)

(21) Appl. No.: 16/306,924

(22) PCT Filed: Jun. 5, 2017
(86) PCT No.: PCT/GB2017/051603

§ 371 Date: Dec. 4, 2018

(30) Foreign Application Priority Data
Jun. 6, 2016 (GB) 1609856.8

(51) Int. Cl. G01N 15/02

(52) U.S. Cl. CPC G01N 15/0266; G01N 2015/0096

(57) ABSTRACT

A particle size sensor for metallic powder includes a microwave cavity or waveguide, the microwave cavity or waveguide including a microwave source for generating microwaves within the microwave cavity or waveguide, a microwave receiver for detecting microwaves generated within the cavity or waveguide, a sample insertion point for receiving a sample of the metallic powder and an analyser arranged to determine a particle size for the metallic powder from receiver signals generated by the receiver.

### FIELD OF INVENTION

This invention concerns a particle size sensor for metallic powders. This invention has particular, but not exclusive, application to use of the particle size sensor in an additive manufacturing apparatus and measuring a particle size of metallic powder recovered from a processing chamber of an additive manufacturing apparatus.

### BACKGROUND

Since the first demonstration of sintering a metal powder body by microwave radiation¹, efforts to understand the energy absorption of conducting metal powders has been ongoing. A variety of studies have taken a first principles approach to the theoretical understanding of absorption of an individual particle within both electric and magnetic fields^{2,3,4}. It is accepted that, for any practical size of particles which are considered to be metallic on the basis of a high value of electrical conductivity, magnetic absorption via eddy current loss is much greater than loss in an equivalent electric field and this has been demonstrated experimentally^{5,6}.

With this in mind, previous works have been undertaken to experimentally verify the absorption in metallic powders by applying high power microwave radiation and measuring the powder temperature. This has been done relatively successfully by measuring the temperature gradients and maximum temperature achieved⁷. The peak absorption rates, as predicted at specific particle sizes by theory, have also been observed experimentally^{8,9}. However, using the temperature as a measure of the absolute absorption has many difficulties. Firstly, the precise power delivered to the sample must be calculated and this may not be trivial due to the complex loading and changing condition of the applicator caused by the heated powder. Also, accurate determination of other powder characteristics will likely be difficult. For instance, the powder thermal conductivity and dissipation rates can be massively affected by the ambient conditions, such as initial temperature and airflow, and other powder characteristics such as packing density, sample size and chemical composition.

Determination of the particle size distribution for a powdered material is currently a relatively expensive or inconvenient process. In an industrial setting, a survey using scanning electron microscopy (SEM) is usually prohibitively expensive. Laser diffraction is the standard measurement used but this usually requires that the powder is well-dispersed in liquid, a process which in metals is prone to error due to its high density. Furthermore, these systems require significant ongoing maintenance and replenishment of consumables which makes them unattractive for many applications.

### SUMMARY OF INVENTION

According to a first aspect of the invention there is provided a particle size sensor for metallic powder, the sensor comprising a microwave cavity or waveguide, the microwave cavity or waveguide comprising a microwave source for generating microwaves within the microwave cavity or waveguide, a microwave receiver for detecting microwaves generated within the cavity or waveguide, a sample insertion point for receiving a sample of the metallic powder and an analyser arranged to determine a particle size for the metallic powder from receiver signals generated by the receiver.

In this way, information regarding the particle size, such as an average particle size, for the metallic powder can be obtained non-destructively. This information can be useful, for instance, in determining the evolution of powder properties over time, such as in additive manufacturing apparatus. Furthermore, the sensor can be embodied as a simple metal structure for the cavity or waveguide and solid-state electronics, allowing interrogation of the sensor into apparatus, such as additive manufacturing apparatus. Sample preparation is minimal and the technique is flexible to allow measurements at elevated temperatures.

The analyser may be arranged to determine a particle size from a change in losses within the sensor due to the introduction of the sample into the microwave cavity or waveguide and/or magnetisation of the sample, as driven by the magnetic field.

The analyser may be arranged to determine from the receiver signals a perturbation of the magnetic field generated in the cavity or waveguide when the sample is present from a reference magnetic field and determine the particle size from the perturbation.

The reference magnetic field may be a magnetic field generated in the cavity or waveguide in the absence of metallic powder. In such an embodiment, the determination may comprise determination of an absolute value of particle size.

Alternatively, the reference magnetic field may be a magnetic field generated when a reference metallic powder, such as a metallic powder having a known particle size or an initial batch of metallic powder to be used in a manufacturing process, is present in the cavity or waveguide. In such an embodiment, the particle size may be a relative difference in the particle size of the sample from the reference metallic powder or a relative change in the particle size.

The perturbation may be determined by measuring a power of receiver signals. Additionally, the perturbation may be determined by measuring a phase of the receiver signals. The power and/or phase may be characterised using scattering parameters (s-parameters).

For a microwave cavity, only the real part of the s-parameters (power) may be used in the determination of the particle size. For a microwave waveguide, both the real and imaginary parts (power and phase) may be used in the determination of the particle size.

The perturbation may be a change in a Q-factor of the microwave cavity. For example, the change in losses within the sensor due to the presence of the sample may be determined by measuring a power of the receiver signals at different microwave frequencies.

The perturbation may be a change in a resonant frequency of the microwave cavity. The magnetization of the sample may be determined from a change in a resonant frequency of the microwave cavity as determined from measurements of a power of the receiver signals at different frequencies.

Microwave cavity perturbation provides a convenient method for determining the absolute absorption of a powder. Using cavity modes which isolate the electric and magnetic fields at the sample insertion point, magnetic and electric absorption can be measured separatelyl^{0,11,12,13}. High Q cavities and modern network analyzers ensure that measurement error is extremely small and modern simulation tools have allowed for accurate correction of errors caused by sample holes and coupling structures¹⁴.

Another advantage is the use of multiple modes to provide simultaneous measurements at different frequencies¹⁵.

The sensor may further comprise a controller for controlling the microwave source such that a transmission mode of the microwaves in the microwave cavity or waveguide satisfy the condition that an electric field is substantially zero at the sample and/or that an energy integrated across the sample for the electric field is at least two orders of magnitude below that for the magnetic field. The sample insertion point may have a required geometry such that one or more transmission modes of the microwaves satisfy the above condition. In this way, the perturbation of the microwave field caused by the sample can be attributed to interaction of the sample with the magnetic field. Absorption of the magnetic field can be associated with particle size whereas electric filed absorption does not show the same dependence on particle size.

The controller may be arranged to control the microwave source such that, during determination of a sample, a plurality of transmission modes are generated, the analyser arranged to determine particle sizes for the sample for each transmission mode.

The cavity may have a cross-section having a rectangular or regular polygon shape. Such shapes may facilitate modelling of the microwave cavity. In one embodiment, the microwave cavity comprises a cylindrical cavity. The sample insertion point may be arranged to contain a cylindrical volume of the metallic powder coaxial with the cylindrical cavity.

The sensor may comprise a container transparent to microwaves for holding the metallic powder. The container may be removably insertable into the cavity at the sample insertion point. The container may be made of fused quartz.

The container may have a form based upon a shape of the fields generated by the transmission mode used during measurement. In particular, the container may comprise a form such that the sample of metallic powder contained therein is within a region of the microwave cavity or waveguide that satisfies the condition that an electric field is substantially zero at the sample and/or that an energy integrated across the sample for the electric field is at least two orders of magnitude below that for the magnetic field. The container may have a form that has cylindrical or spherical symmetry. The container may have a cylindrical form. For example, the cylindrical container may be arranged to be inserted into the cylindrical cavity such that an axis of the cylindrical container is coaxial with an axis of the cylindrical cavity.

The sensor may comprise a compactor for compacting the metallic powder in the container. The compactor may comprise a vibrator for vibrating the container.

The sensor may comprise a temperature regulator for regulating a temperature of the microwave cavity or waveguide. The temperature regulator may comprise a heater and/or cooler for heating and/or cooling the microwave cavity or waveguide. The temperature regulator may comprise a temperature sensor for measuring a temperature of the microwave cavity or waveguide. The temperature regulator may be arranged to heat or cool the microwave cavity or waveguide based upon the temperature sensor to ensure that the temperature of the microwave cavity or waveguide is within a predefined temperature range.

According to a second aspect of the invention there is provided a method of determining a particle size for a metallic powder comprising inserting a sample of the metallic powder into a microwave cavity or waveguide, generating microwaves within the microwave cavity or waveguide, detecting microwaves generated within the cavity or waveguide and determining a particle size from the detected microwaves.

The particle size may be determined from a change in losses within the sensor due to the introduction of the sample into the microwave cavity or waveguide and/or magnetisation of the sample, as driven by the magnetic field.

The particle size may be determined from a perturbation of the magnetic field generated in the cavity or waveguide when the metallic powder is present from a reference magnetic field.

The reference magnetic field may be a magnetic field generated in the cavity or waveguide in the absence of metallic powder. In such an embodiment, the method may comprise determining an absolute value of particle size.

Alternatively, the reference magnetic field may be a magnetic field generated when a reference metallic powder, such as a metallic powder having a known particle size or an initial batch of metallic powder to be used in a manufacturing process, is present in the cavity or waveguide. In such an embodiment, the method may comprise determining a particle size relative to a measured particle size of the reference metallic powder or a relative change in the particle size.

Determining the perturbation may comprise measuring a power of receiver signals. Additionally, determining the perturbation may comprise measuring a phase of the receiver signals.

The power and/or phase may be characterised using scattering parameters (s-parameters). For a microwave cavity, only the real part of the s-parameters (power) may be used in the determination of the particle size. For a microwave waveguide both the real and imaginary parts (power and phase) may be used in the determination of the particle size.

The perturbation may be a change in a Q-factor of the microwave cavity. For example, the change in losses within the sensor due to the presence of the sample may be determined by measuring a power of the detected microwaves at different microwave frequencies.

The perturbation may be a change in a resonant frequency of the microwave cavity. The magnetization of the sample may be determined from a change in a resonant frequency of the microwave cavity as determined from a power of the detected microwaves at different frequencies.

The method may comprise generating microwaves in the cavity or waveguide such that a transmission mode of the microwaves in the microwave cavity or waveguide satisfy the condition that an electric field is substantially zero at the metallic powder and/or that an energy integrated across the metallic powder for the electric field is at least two orders of magnitude below that for the magnetic field. In this way, the perturbation of the microwave field caused by the sample can be attributed to interaction of the sample with the magnetic field. Absorption of the magnetic field can be associated with particle size whereas electric filed absorption does not show the same dependence on particle size.

The method may comprise generating a plurality of transmission modes in the microwave cavity or waveguide and determining an absorption value for the metallic powder for each transmission mode.

The method may comprise compacting the metallic powder before exposing the metallic powder to the microwaves. The metallic powder may be compacted using vibration.

The method may comprise regulating a temperature of the microwave cavity or waveguide. The method may comprise regulating the temperature to maintain the temperature within a predefined temperature range.

According to a third aspect of the invention there is provided an analyser for determining a particle size for a metallic powder, the analyser comprising a processor arranged to receive a signal indicative of detected microwaves in a microwave cavity or waveguide containing a sample of the metallic powder, determine from the detected signal a change in the microwave field generated in the microwave cavity or waveguide when the sample is present compared to a reference condition, and determine a particle size for the metallic powder from the change.

The change in the microwave field may be indicative of a change in losses within the sensor due to the introduction of the sample into the microwave cavity or waveguide and/or magnetisation of the sample, as driven by the magnetic field.

The reference condition may be a loss within the sensor, phase or resonant frequency of the microwaves in the microwave cavity or waveguide when no metallic powder is present in the microwave cavity or waveguide. Alternatively, the reference condition may be a loss within the sensor, phase or resonant frequency of the microwaves in the microwave cavity or waveguide when a reference metallic powder is present in the microwave cavity or waveguide.

According to a fourth aspect of the invention there is provided apparatus for handling a metallic powder comprising a sensor for monitoring a particle size of the metallic powder, the sensor comprising a microwave cavity or waveguide, the microwave cavity or waveguide comprising a microwave source for generating microwaves within the microwave cavity or waveguide, a microwave receiver for detecting microwaves generated within the cavity or waveguide, a sample insertion point for receiving a sample of the metallic powder and an analyser arranged to monitor the particle size of the metallic powder from receiver signals generated by the receiver; and a controller arranged to generate an output based upon the monitored particle size.

The output may be a log of measurements of particle size. Additionally or alternatively, the output may be generation of an operator alert indicating to an operator that the particle size of the powder is outside of acceptable limits. The output may be a control signal for changing an operation of the apparatus, for example stopping operations of the apparatus.

The apparatus may comprise an additive manufacturing apparatus, which builds workpieces by solidification of metallic powder in a layer-by-layer manner. The additive manufacturing apparatus may comprise a selective melting or sintering apparatus in which powder is dispensed to form layers of a powder bed, wherein selected areas of each layer are solidified using an energy beam to form the workpiece. The sensor may be arranged to measure samples of the metallic powder before dispense of the metallic powder to the powder bed. The additive manufacturing apparatus may comprise a powder transport device for transporting powder recovered during the build and/or from the powder bed at the end of a build back to a hopper for dispense in a subsequent build, wherein the sensor is arranged to monitor the size of particles in powder recovered from the powder bed.

The controller of the additive manufacturing apparatus may be arranged to generate the operator alert if a power loss factor, such a Q-factor, phase and/or resonant frequency for the microwave cavity or waveguide deviates outside of a preset acceptable threshold. The acceptable threshold may define a deviation of the power loss factor phase and/or resonant frequency from a reference power loss factor, phase and/or resonant frequency, for example a factor calculated for a reference, such as initial, batch of metallic powder. The sensor may be used to determine when a particle size of the metallic powder in the apparatus moves outside of an acceptable threshold compared to an initial batch of metallic powder having a known particle size. For example, when a fresh batch of powder is first introduced into the apparatus, a power loss factor in the cavity or waveguide may be determined for the fresh powder and used as the reference power loss against which subsequent measurements are made as the powder is used in the apparatus and changes in average particle size occur.

An advantage of the sensor is that it allows non-destructive testing of the powder in the apparatus such that the tested powder can be reused within the apparatus.

The sensor may be used in other apparatus such as powder manufacturing apparatus, powder recycling apparatus, metal injection molding apparatus, laser cladding apparatus and blown powder direct metal deposition apparatus.

### BRIEF DESCRIPTION OF THE DRAWINGS

FIG. 1 is a comparison of simulation and theory of the absorption and permeability of a single particle (the theory curves are given by Equations 2 and 3);

FIG. 2 shows hexagonally close packed (HCP) particles generated using a COMSOL Metaphysics simulation;

FIG. 3 shows COMSOL simulation results based on the 216 particle HCP array;

FIGS. 4a and 4b show magnetic field strength in cross-section in the x-y plane through the third particle plane, FIG. 4a. separated HCP particle matrix and FIG. 4b. touching HCP particle matrix;

FIG. 5 shows two COMSOL simulation results based on the 216 particle HCP array with separated layers;

FIG. 6 shows simulated magnetic absorption of a 3×3×3 HCP particle matrix;

FIG. 7 shows the 3D model of particles used for a multi-layer cubic close packed periodic simulation;

FIG. 8 is a graph showing the results for the simulation carried out with the particle model shown in FIG. 7;

FIG. 9 shows the particle size distribution of Ti6Al4V powder after being progressively sieved into four separate fractions;

FIG. 10 shows optical microscope images of the fractioned powder;

FIG. 11 shows measured magnetic absorption for samples of each powder fraction;

FIG. 12 shows measured Real permeability for the samples of each powder fraction;

FIG. 13 shows the measured relative absorption compared with theoretical absorption for a single isolated particle;

FIG. 14 is a perspective view of a sensor according to an embodiment of the invention;

FIG. 15 is a schematic view of a powder handling apparatus incorporating a sensor according to an embodiment of the invention; and

FIG. 16 is a schematic view of an additive manufacturing apparatus incorporating the sensor according to an embodiment of the invention.

### DESCRIPTION OF EMBODIMENTS

Referring to FIG. 14, a sensor according to an embodiment of the invention comprises a microwave cavity 201, in this embodiment a cylindrical microwave cavity. The cavity 201 comprises a microwave source for generating microwaves within the microwave cavity 201 and a microwave receiver for detecting microwaves generated within the cavity 201. In this embodiment, the microwave source and microwave receiver are provided, respectively, by coaxial lines 202, 203 with cavity coupling achieved using two near-identical coupling loops 202′, 203′ fed through the flat, top surface of the microwave cavity 201.

A sample insertion point 204 is provided at a centre of the microwave cavity 201 for receiving the metallic powder sample. In this embodiment, the sensor further comprises a cylindrical container 205 in the form of a fused quartz tube removably insertable into the sample insertion point 204. The quartz tube 205 is arranged to hold the metallic powder sample to be measured.

A microwave network analyser 206, in this embodiment an Agilent PNA-L (N5232A) microwave network analyser, is connected to the coaxial lines 202, 203. The microwave network analyser 206 is arranged to generate a microwave signal along coaxial line 202 to generate microwaves in the cavity 201 and to analyse microwave receiver signals received along coaxial line 203. The network analyser 206 analyses the receiver signal to determine an average particle size for the metallic powder. For example, the average particle size may be determined in the manner described below with reference to the Example.

### EXAMPLE

Theoretical Considerations and Simulation

The complex magnetic dipole moment for an individual spherical particle is derived as²

$$m = 2 π {a}^{3} {H}_{0} ( \frac{( μ + 2 ) ( 1 - ka cot ( ka ) - {μ ( ka )}^{2} )}{( μ - 1 ) ( 1 - ka cot ( ka ) - {μ ( ka )}^{2} )} ) \qquad ( 1 )$$

where a is the particle radius, H₀ is the applied magnetic field strength, ε is the internal sphere permittivity, μ is the internal sphere permeability and the wavelength

$$k = \frac{ω \sqrt{ɛμ}}{c} .$$

Electrical conductivity σ is introduced by making ε complex, i.e. by considering ε=ε₁−jσ/ωε₀, where the imaginary part dominates the real part ε₁ for materials considered to be weakly conducting, and certainly so for materials considered to be metallic.

This leads to simplified expressions for the power absorbed per unit volume and the real part of the relative permeability for a non-magnetic conducting powder as

$$\begin{matrix}〈 {P}_{M} 〉 = \frac{3}{4} {ωμ}_{0} {H}_{0}^{2} Im ( 1 + \frac{3 cot ( ka )}{ka} - \frac{3}{{( ka )}^{2}} ) & ( 2 ) \\ {μ}_{1} = 1 - \frac{1}{2} Re ( 1 + \frac{3 cot ( ka )}{ka} - \frac{3}{{( ka )}^{2}} ) & ( 3 )\end{matrix}$$

Considering the large skin depth limit, a/δ<<1 we see that for small particles

$${lim}_{\frac{a}{δ} \to 0} 〈 {P}_{M} 〉 = \frac{1}{20} {ω}^{2} {μ}_{0}^{2} {a}^{2} σ {H}_{0}^{2} ∝ {ω}^{2} {a}^{2} σ \qquad ( 4 )$$

Conversely, in the small skin depth limit, we see that for large particles

$${lim}_{\frac{a}{δ} \to ∞} 〈 {P}_{M} 〉 = \frac{9}{4 a} \sqrt{\frac{ω {μ}_{0}^{2}}{2 σ}} {H}_{0}^{2} ∝ \frac{1}{a} \sqrt{\frac{ω}{σ}} \qquad ( 5 )$$

As can be seen, for fixed value of frequency, the absorption in large particles is inversely proportional to the particle radius and proportional to the square of the radius for small particles. This reveals an absorption peak which is found when the radius is 2.4 times as large as the skin depth.

The above results are for isolated spheres, so a key assumption is that the particles are arranged suitably sparsely such that local field corrections caused by particle-particle interactions can be ignored. However, meeting this criterion in reality is difficult due to the nature of the powder itself. Attempts to suspend the powder in some type of setting liquid are unlikely to be successful due to the high density of the individual particles, thus leading to particle settling. The relevance of the equations is therefore in question but this can be answered, to some extent, with simplified simulations.

Simulations were undertaken using COMSOL Multiphysics at 2.45 GHz and are a quasi-static approximation. A uniform magnetic field of amplitude 1 A/m was applied in a region of space with boundaries kept suitably far away from the particles such that the magnetic field at the boundary is unaffected by local field corrections owing to the particles. This condition mirrors the assumption made when applying first order perturbation theory. The simulations are not intended to completely characterize the absorption for multi-particle systems but simply give an indication of their behavior. In order to characterize the absorption empirically, many different packing schemes would need to be considered as well as various field orientations. In the first instance and for this case, a simple hexagonal close packed (HCP) system was used as it gives a relative packing density close to what was measured during experimentation (˜0.6). The particle radius is fixed at 20 μm and the electrical size is changed by adjusting its conductivity—thus changing the ratio of skin depth to particle radius. Initially a single particle was simulated to verify future simulations, as shown in FIG. 1. The simulation shows very good agreement with the analytical theory, demonstrating the characteristic absorption peak when a=2.4δ. For completeness, the theoretical real permeability is shown, even though this was not calculated by simulation.

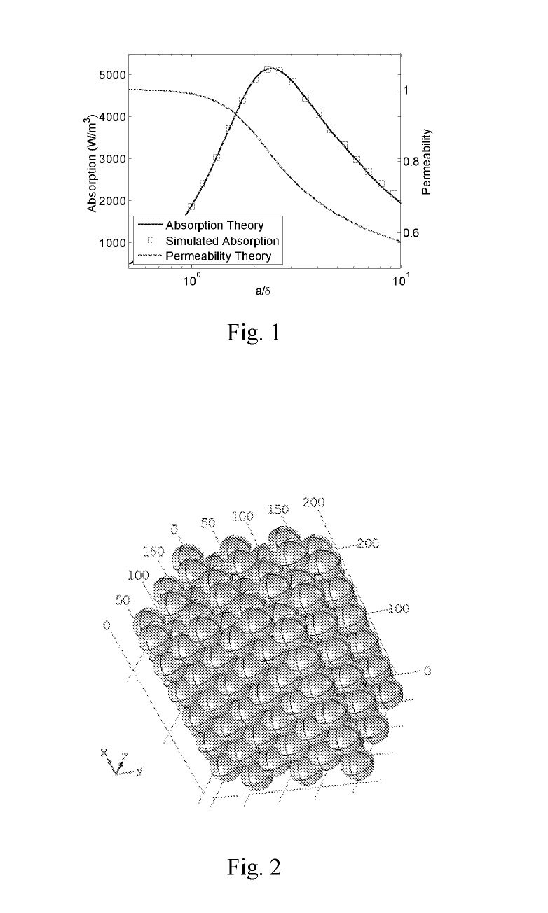

The next 3D simulation considers a hexagonally close packed matrix of 216 particles (i.e. 6×6×6). The generated particle agglomeration can be seen in FIG. 2. Note the axis directions, which are referred to later. The HCP planes are stacked in the z direction.

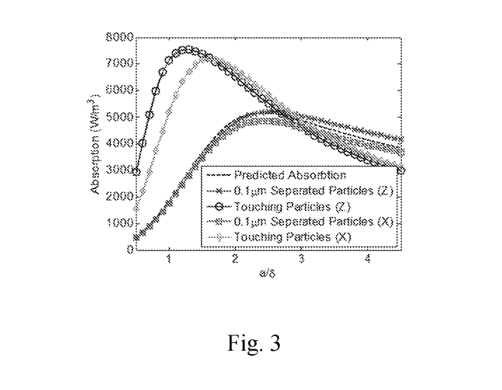

Four distinct conditions are considered: the field applied in either x or z direction and with the particles either touching or with a 0.1 μm gap separating all particles. The z direction indicates field application perpendicular to the 6 HCP planes. FIG. 3 shows the result of these simulations with the touching and separated cases showing distinct results.

With small inter-particle separation, the measured absorption closely resembles the profile predicted by the earlier theory. This is enabled by total magnetic field penetration in the space between particles.

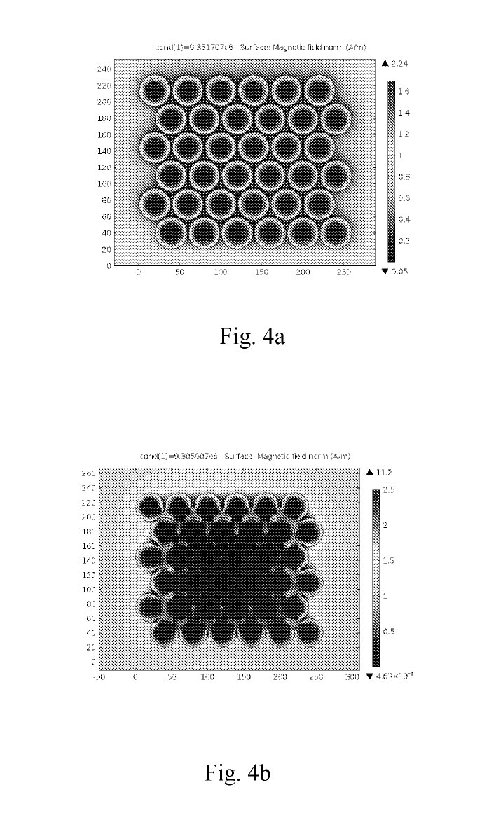

FIG. 4 shows the magnetic field distribution on the cross section drawn through the middle of the particles in both the separated and touching cases. The radius is 6 times the skin depth and the magnetic field is applied in the z direction, i.e. perpendicular to the plane of the image. As previously mentioned, the separated case allows total field penetration. However, with no separation, electrical contacts between particles enable macro currents to flow in the agglomeration. These currents screen the inner particles and cause a different absorption characteristic. This can be interpreted as the small particles combining to effectively increase the particle size and due to the voids effectively trapped by the touching particles, the peak absorption per unit volume is increased.

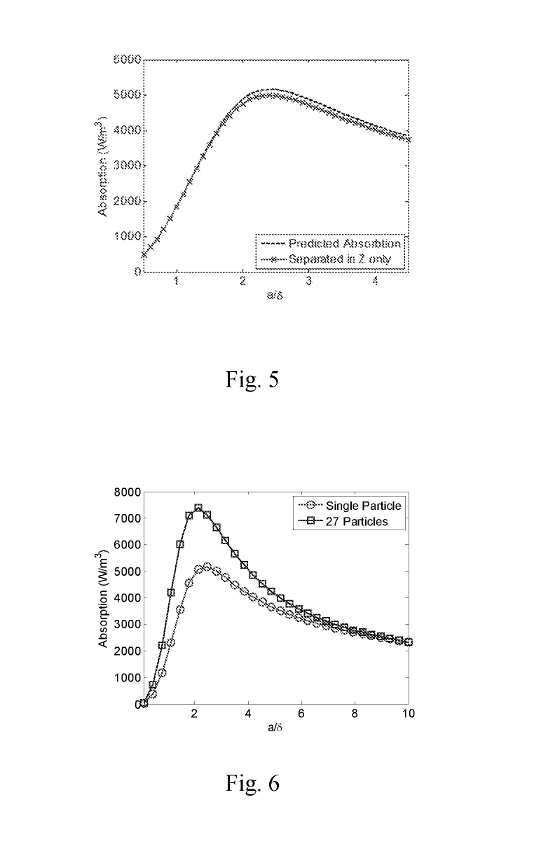

It is important to note that these currents flow in a perpendicular direction to the applied magnetic field. Therefore, only contacts made in the direction perpendicular to the applied field contribute to the overall screening affect. This can be demonstrated by considering the same 216 particle matrix with the field applied in the x direction but with the HCP planes slightly separated, thus eliminating any electrical contacts in the z direction. FIG. 5 shows the absorption characteristic which closely matches the theoretical prediction. The weight of a sample means that the majority of electrical contacts occur at polar ends of the particles. If the field is applied in the same direction as gravity, these contacts are relatively inconsequential.

A further interesting effect is also observed when considering small particle agglomerations. A touching 3×3×3 HCP was constructed and simulated with field applied in the z direction. FIG. 6 shows the results and, in contrast to the larger case, the per unit volume absorption still exhibits a peak in a similar location but the absorption is significantly increased in magnitude.

It is hypothesized that, as long as electrical contact is not made between particles, a relatively large group of closely packed particles will share the absorption behavior of a single particle up to (and close to) the absorption peak. The isolation between light particle contacts in the plane perpendicular to the magnetic field can be provided by the native oxide layer that will be present on the surfaces of many metal particles. It is not expected that this oxide layer will contribute significantly to the magnetic absorption, as reported previously¹⁶.

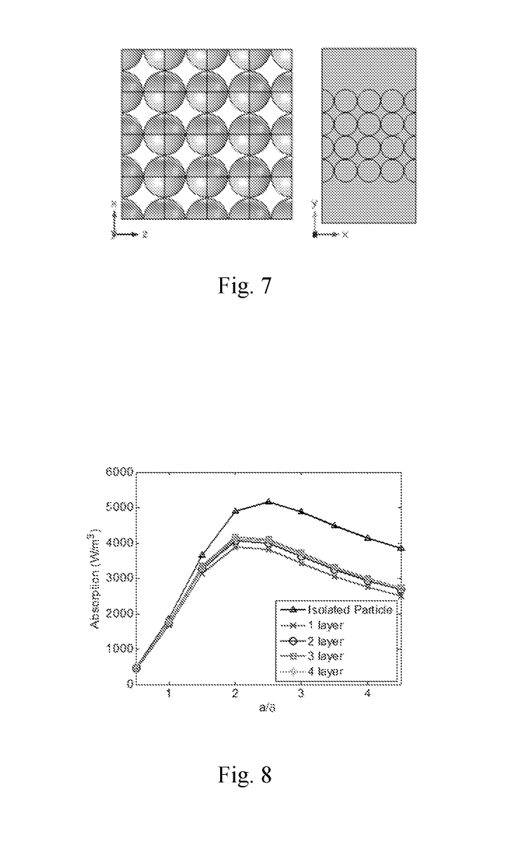

An effort was made to simulate an infinitely large configuration by utilizing the simple symmetry of a cubic close packed system and a periodic boundary condition (density=0.52). FIG. 7 shows the 3D model created for simulation where the excitation ports are placed at the y limits and a periodic condition applied at the x and z limits. As defined by the periodic boundary conditions, the simulation is continuous across the x and z boundaries. In the y direction, the simulation is finite. Simulations of up to 4 layers in this direction are considered, where the number of layers is denoted by N. The boundaries at y are places sufficiently far away such that they do not influence local field distortions caused by the particles. Adjusting the distance between the particles and simulation boundary did not significantly affect simulation results.

The absorption, presented as the average absorption in the center 9×N particles, is shown in FIG. 8. It can be seen that, while the curves retain the approximate characteristic shape of absorption, significant reduction of loss is observed as the particles increase in size. Whilst a slight decrease in absorption can be seen for 1 layer, subsequent simulations show a very similar results, thus adding confidence that the result is scalable to larger geometries.

Microwave Cavity Setup

A cylindrical cavity as described with reference to FIG. 14 was used having an internal radius 4.75 cm and height 4 cm. The microwave cavity was machined from aluminium. A hole was placed on its axis, with a suitable RF choke, to act as a mode trap for degenerate TM modes (explicitly TM₁₁₁, TM₁₁₂ and TM₁₂₂ in this case). By exploiting different resonant modes, a sparse frequency spectrum is obtained. As well as changing the absolute absorption for particular particle sizes, this shifts the absorption peak due to the changing skin depth. Table I shows the different modes utilized and their measured resonator parameters (the mode scaling constants G are defined below).

TABLE I
Utilized Modes

| | Frequency | | |
|---|---|---|---|
| Mode | (GHz) | Q₀ | Gₙₘₚ |
| TE₀₁₁ | 5.36 | 20062 | 0.284 |
| TE₀₁₂ | 8.39 | 17917 | 0.490 |
| TE₀₂₂ | 10.2 | 26711 | 0.128 |

Resonator Q and frequency were obtained, simultaneously, from all the modes, from measurements of the voltage transmission coefficient S₂₁ in the frequency domain using the Agilent PNA-L (N5232A) utilizing a circle and linear fit strategy, as detailed elsewhere¹⁸. This method, using a very small span of points around the center frequency, was found to be more robust compared to a Lorentzian fit of the magnitude data. This is especially true for the higher order modes where distortion of the resonances due to cross-coupling becomes significant.

The per unit volume magnetic power absorption (in W/m³) is given as

$$〈 {P}_{M} 〉 = \frac{ω}{2} {μ}_{2} {μ}_{0} {H}_{0}^{2} \cdot β \qquad ( 6 )$$

where β is the relative density of the powder sample. The imaginary part of permeability can be obtained through standard perturbation as¹⁴

$${μ}_{2} \approx ( \frac{1}{{Q}_{0}} - \frac{1}{{Q}_{S}} ) \frac{{V}_{C}}{{V}_{S}} {G}_{nmp} \qquad ( 7 )$$

where Q₀ is the initial resonator quality factor, Qₛ is the resonator Q with sample, V_{C} is the cavity volume, V_{S} is the sample volume and Gₙₘₚ is a mode dependent scaling constant. The G values can be determined experimentally or via simulation, as demonstrated by Cuenca et al. using a COMSOL simulation.¹⁹

The real permeability was also measured using the frequency shift of the resonant cavity¹⁴.

$${μ}_{1} \approx ( \frac{{f}_{0} - {f}_{s}}{{f}_{0}} ) \frac{{V}_{C}}{{V}_{S}} {G}_{nmp} + 1 \qquad ( 8 )$$

The samples selected for testing were made from gas atomized Ti6Al4V powder obtained from the manufacturer LPW Technology Ltd. Ti6Al4V is a common Titanium alloy frequently used in aerospace and medical applications due to its high strength and biocompatibility²⁰. Chemically, it is composed of 6% Aluminium, 4% Vanadium and 90% Titanium.

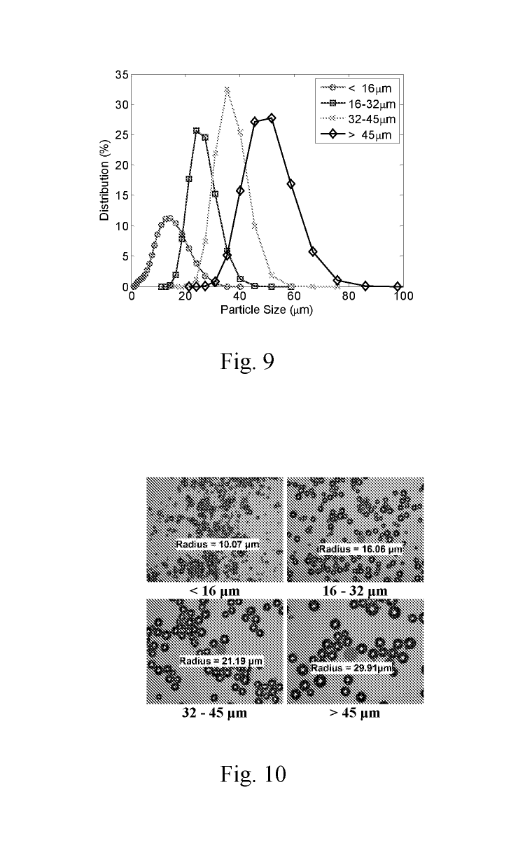

As Ti6Al4V is not usually used for its conductive properties, there is uncertainty regarding its conductivity. However, the bulk conductivity is assumed to be approximately 6×10⁵ S/m 6×10⁵ S/m²¹. The standard powder is described to have particles in the range 16-45 μm and was progressively sieved into 4 separate powder fractions. The resultant particle size distributions (PSD), obtained from a Malvern Mastersizer 3000, can be seen in FIG. 9.

The three larger fractions appear approximately symmetrical, however, the smallest is broader. This similarity is also shown in the physical look and feel of the powders. The three larger fractions appear identical: light grey in colour and smoothly flowing. However, the smaller fraction is slightly darker and tends to form powder clumps. Imaging the separate fractions with optical microscopy utilizing focus stacking illustrates the cause of this difference. FIG. 10 shows the four particle fractions at ×20 magnification. In each case, the radius of a single highlighted particle has been measured to illustrate the relative size of the particles in each fraction. Firstly, the images reveal the powder particles are highly spherical, adding confidence that the previous analysis will be valid. Secondly, whilst small satellite particles are visible in all fractions, the smallest fraction shows a large concentration of these small sub-micron size particles. In this fraction, each larger particle is surrounded by many very small particles which appear to then cause clumps of small particles to form.

Samples were prepared by placing them into the fused quartz tubing (obtained from CM Scientific Ltd, UK) with 1.5 mm ID and 1.8 mm OD. Subsequently they were vibrated for 10s on a basic vibration platform at 100 Hz. The sample was not seen, visually, to compact any further for longer vibration durations. This ensured the removal of any air pockets and, as a result, resulted in uniform density. For a tall sample, significant granular convection is not expected but the vibration time is kept intentionally minimal to avoid any potential error. The samples were weighed, accurate to ±0.001 g, and the relative density calculated given the bulk density of Ti6Al4V of 4.43 gcm^{-3 21}. Details of the 4 samples can be seen in Table II.

TABLE II
Powder Characteristics

| | Average Particle | Effective |
|---|---|---|
| Fraction | Size (μm) | Density |
| <16 μm | 13.2 | 0.54 |
| 16-32 μm | 25.8 | 0.58 |
| 32-45 μm | 36.1 | 0.58 |
| >45 μm | 47.9 | 0.60 |

Results

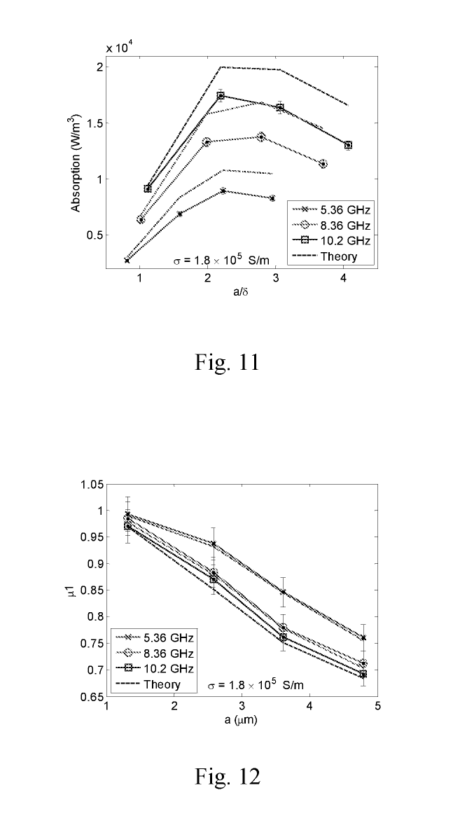

The absorption results can be seen in FIG. 11. A set of predicted values were obtained by performing a weighted sum of the absorption given by Equation 2 over the entire PSD. The particle size for each fraction is taken as the average particle size within the distribution. The model appears to accurately predict the absorption profile of the powder. The absorption peak is observed and is seen to be at a fixed skin depth ratio.

The real permeability, plotted alongside a set of theoretical curves given by Equation 3, are shown in FIG. 12.

The errors plotted are the combination of the random errors encountered in Q and frequency measurement and other systematic errors. The vast majority of the error is caused from a conservative uncertainty in the mode scaling factor G (˜2%) and the measurement error in sample volume used to calculate the powder density.

Discussion

The frequency shift and resultant real permeability shows a strong negative trend with increasing particle size. Within this range, the values appear consistent with those predicted by the presented theory.

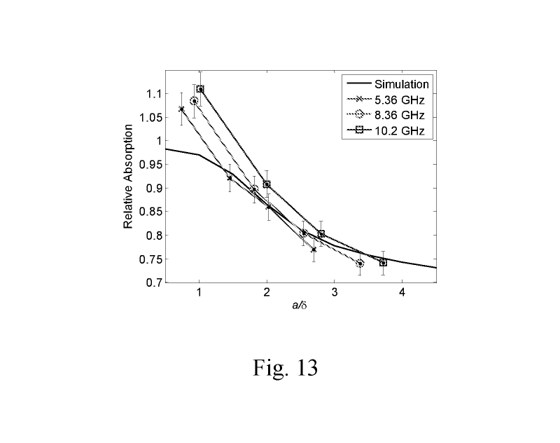

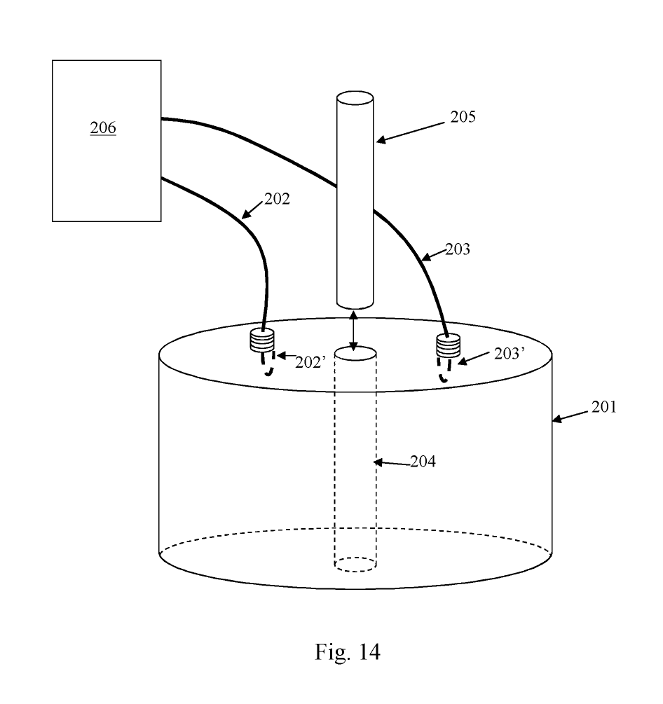

The measured loss values also show strong correlation with the theory. FIG. 13 shows the measured relative absorption compared with the single theoretical isolated particle case. A curve is also given showing the result of the periodic simulation. Consistent with the simulation, the larger fractions show relatively reduced absorption with increased particle size. However, the smaller fraction, where the majority of particles are below the skin depth limit, do not follow the trend exhibiting enhanced absorption per unit volume.

This outlier can be explained by the previously mentioned differences of this powder fraction. Firstly, the particles have a tendency to cluster together. Assuming these clusters form electrically connecting networks, the result of this is an increased effective particle size without, however, a corresponding increase in weight. Therefore, the absorption per unit volume is seen to increase. This effect was demonstrated in the earlier simulation in the case of touching particles. Secondly, this fraction has a concentrated proportion of very small particles many of which are small pieces of debris formed during the gas atomization process. Particles forming this debris are less likely to be spherical in nature and therefore less likely to conform to theoretical predictions.

The larger particle case, although initially following the prediction, proceeds to exhibit enhanced absorption. This is a surprising result but one that can be explained by the earlier simulation. During heating, the particles will thermally expand. Although this expansion is relatively small, not causing significant change to the electrical size, it will cause an increased density of electrical contacts. The increased density of contacts is not sufficient to cause a reduction of the absorption caused by screening but the contacts create small particle agglomerations which show increased absorption per unit volume, as demonstrated by the earlier simulation. It is expected that this behavior will be strongly dependent on the sample container geometry.

### CONCLUSION

These results show that a sensor can be constructed to assess evolution of particle size of a powder within an industrial process or to simply assess a powder based on microwave perturbation. Reduced absorption, compared with the single particle case, was observed in all cases for particles bigger than the skin depth. However, the absorption peak was relatively unchanged and, within the tested range, absorption was no worse than 75% of the ideal case. When heating the powder, some non-linear behavior was observed at high temperature due to particle thermal expansion causing particle agglomeration.

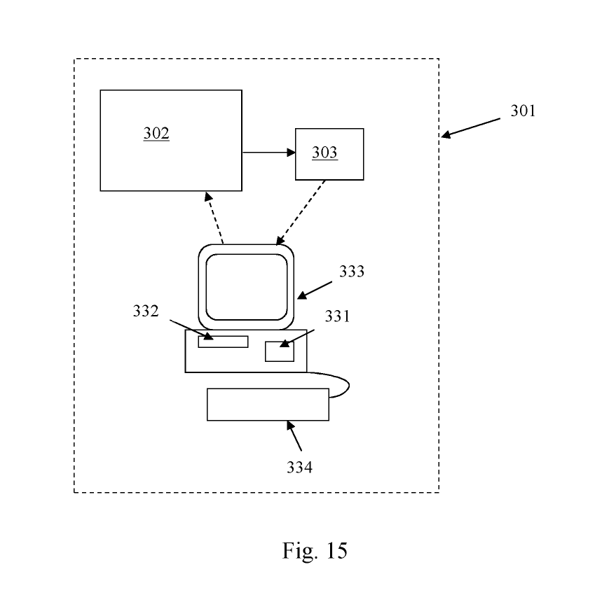

Referring to FIG. 15, the particle size sensor 302 may be used in a powder handling apparatus 301 to measure the particle size of powder used by or manufactured by the powder handling apparatus 301. The powder handling apparatus may comprise a device 302, for example powder manufacturing apparatus, powder recycling apparatus, metal injection molding apparatus, laser cladding apparatus or blown powder direct metal deposition apparatus. Sensor 301 is connected to the device 303 such that powder samples are delivered thereto, for example, for periodic measurements. The sensor may be arranged such that the powder samples are returned to the device 303 after the measurement.

A controller 330 is connected to the sensor 302 and the device 303. The controller 330 comprises a processor 331, memory 332, display 333 and input device 334, such as a keyboard. Software stored in memory 332 causes the controller 330 to analyze the measurements from the sensor 302 and generate an appropriate message on display 333 and/or control the device 303 based upon the measurements of particle size. For example, the message generated on the display 333 may be an alert to the operator that the measured particle size has fallen outside of preset limits. The controller 330 may control the device 303, either automatically or in response to an operator input in response to the message. For example, processes carried out by the device 303 with the powder may be halted or the process modified in order to maintain the particle size within the present limits.

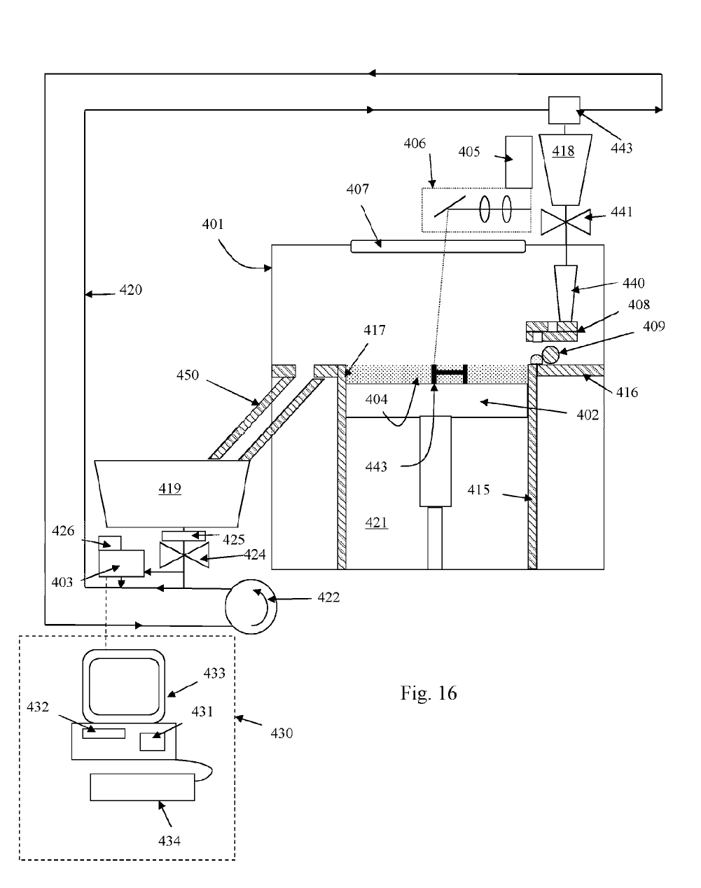

FIG. 16 shows an additive manufacturing apparatus comprising a particle size sensor 403 according to an embodiment of the invention. The additive manufacturing apparatus comprises a build chamber 401 having therein partitions 415, 416 that define a build volume 417 and a surface onto which powder can be deposited. A build platform 402 is provided for supporting a part 443 built by selective laser melting powder 404. The platform 402 can be lowered within the build volume 417 as successive layers of the part 443 are formed. The build volume 417 and build platform 402 may have any suitable cross-sectional shape, such as circular, rectangular and square. Seals (not shown) around the build platform 402 prevent powder from entering into the lower chamber 421.

Layers of powder 404 are formed as the part 443 is built by dispensing apparatus 408 for controlled dispense from a hopper 440 and an elongate wiper 409. For example, the dispensing apparatus 408 may be apparatus as described in WO2010/007396. An overflow channel 450 is provided to a side of the build volume opposite the hopper 340 for collecting excess powder that is spread across the working area by the wiper 309 as well as providing a channel for the recovery of powder from the powder bed in the build volume 417 at the end of a build.

A laser module 405 generates a laser for melting the powder 404, the laser directed as required by optical scanner 406 under the control of a controller 430. The laser enters the chamber 401 via a window 407.

The optical scanner 406 comprises steering optics, in this embodiment, two movable mirrors for directing the laser beam to the desired location on the powder bed 404 and focussing optics, in this embodiment a pair of movable lenses for adjusting a focal length of the laser beam. Motors (not shown) drive movement of the mirrors and lenses, the motors controlled by controller 430.

Excess and recovered powder is directed by channel 450 into a collection hopper 419. A powder transport loop 420 is provided for transporting powder from the collection hopper 419 to an intermediate hopper 418. Powder is dispensed from intermediate hopper 421 to dispense hopper 440 under the control of valve 441.

The powder transport loop 420 comprises a pump 422 for generating a flow of inert gas around the loop. Powder entrained in the gas flow is carried to a separator 433, which separates the powder from the gas flow, the powder being deposited into the intermediate hopper 418. Release of powder from collection hopper 419 into the gas flow is controlled by valve 424. The powder from the collection hopper 419 is filtered by sieve 425 before is passes into the powder transport loop 420, the sieve 425 filtering powder particles above a defined threshold, such as 60 μm, from the powder delivered to the powder transport loop 420.

The particle size sensor 403 is provided in the apparatus to measure an average particle size of powder delivered to the powder transport loop 420 after sieving. The particle size sensor 403 may be as described with reference to FIG. 14 with a container arranged to receive a powder sample and be inserted into the microwave cavity for a measurement. The powder sample may then be delivered to the powder transport loop 420 after measurement. A vibrator, such as an ultrasonic vibrator 426, may be provided for compacting the sample in the container prior to measurement.

The controller in the form of computer 430 controls modules of the additive manufacturing apparatus. Computer 430 comprises the processor unit 431, memory 432, display 433, user input device 434, such as a keyboard, touch screen, etc., and a data connection to the modules. Signals generated by sensor 403 are fed to computer 430. Software in memory 432 causes the controller 430 to generate appropriate warning messages on the display 433 if the signals from the sensor 403 fall outside pre-set limits. The computer 430 may also be arranged to halt a build of a part automatically or in response to an operator input if the signals fall outside the pre-set limits.

For example, the sensor 303 may first be calibrated using a powder having a known average particle size, such as an initial batch of powder that may be introduced into the collection hopper 419. The signal may be associated with an absorption of microwaves by the microwave cavity of the sensor 403 with the initial batch of powder. The calibration may set a reference absorption value for the microwave cavity and later signals from the sensor 403 during use of the apparatus may be compared to the reference value to determine whether an evolution of the average particle size of the powder falls outside a pre-set limit.

It will be understood that alterations and modifications can be made to the above described embodiments without departing form the invention as described herein. For example, a microwave waveguide may be used rather than a microwave cavity. A temperature regulator and temperature sensor may be used to maintain a temperature of the particle sensor within desired limits.

### REFERENCES

¹ R. Roy, D. Agrawal, J. Cheng, and S. Gedevanishvili, Nature 399, 668 (1999).
² A. Porch, D. Slocombe, and P. P. Edwards, Phys. Chem. Chem. Phys. 15, 2757 (2013).
³ M. Ignatenko, M. Tanaka, and M. Sato, Jpn. J. Appl. Phys. 48, 067001 (2009).
⁴ K. I. Rybakov, V. E. Semenov, S. V. Egorov, a. G. Eremeev, I. V. Plotnikov, and Y. V. Bykov, J. Appl. Phys. 99, 023506 (2006).
⁵ J. Cheng, R. Roy, and D. Agrawal, J. Materials Sci. Lett. 20, 1561 (2001).
⁶ J. Ma, J. F. Diehl, E. J. Johnson, K. R. Martin, N. M. Miskovsky, C. T. Smith, G. J. Weisel, B. L. Weiss, and D. T. Zimmerman, J. Appl. Phys. 101, 074906 (2007).
⁷A. Mondal, A. Shukla, A. Upadhyaya, and D. Agrawal, Sci. Sinter. 42, 169 (2010).
⁸ K. Kashimura, N. Hasegawa, S. Suzuki, M. Hayashi, T. Mitani, N. Shinohara, and K. Nagata, J. Appl. Phys. 113, 024902 (2013).
⁹ P. Mishra, a. Upadhyaya, and G. Sethi, Metall. Mater. Trans. B 37, 839 (2006).
¹⁰ U. Raveendranath and K. T. Mathew, Microw. Opt. Technol. Lett. 18, 241 (1998).
¹¹ H. Kobayashi and S. Ogawa, Jpn. J. Appl. Phys. 10, 345 (1971).
¹² D. T. Zimmerman, J. D. Cardellino, K. T. Cravener, K. R. Feather, N. M. Miskovsky, and G. J. Weisel, Appl. Phys. Lett. 93, 214103 (2008).
¹³ M. Lin, Y. Wang, and M. N. Afsar, Spectrosc. Mater. Prop. 62, 62 (n.d.).
¹⁴ J. A. Cuenca, E. Thomas, S. Mandal, O. Williams, and A. Porch, in Microw. Conf. (APMC), 2014 Asia-Pacific (Sendai, Japan, 2014), pp. 441-443.
¹⁵ J. A. Cuenca, E. Thomas, S. Mandal, O. Williams, and A. Porch, 63, 4110 (2015).
¹⁶ M. Ignatenko and M. Tanaka, Phys. B Condens. Matter 405, 352 (2010).
¹⁷ T. Galek, K. Porath, E. Burkel, and U. van Rienen, Model. Simul. Mater. Sci. Eng. 18, 025015 (2010).
¹⁸ M. C. Sanchez, E. Martin, and J. M. Zamarro, 136, 147 (1989).
¹⁹ J. A. Cuenca, S. Klein, R. Rüger, and A. Porch, in 44th Eur. Microw. Conf. (Rome, 2014), pp. 128-131.
²⁰ W. D. Callister, Materials Science and Engineering: An Introduction, 6th ed. (Wiley, New York, 2003).
²¹ V. Parshin, E. Serov, K. Van Klooster, and R. Ravanelli, Int. Conf. Microw. Radar Wirel. Commun. 1 (2010).
²² Metals Handbook Volume 1, 8th ed. (American Society for Metals, Novelty, Utah, 1961).

1. A particle size sensor for metallic powder, the sensor comprising a microwave cavity or waveguide, the microwave cavity or waveguide comprising a microwave source for generating microwaves within the microwave cavity or waveguide, a microwave receiver for detecting microwaves generated within the cavity or waveguide, a sample insertion point for receiving a sample of the metallic powder and an analyser arranged to determine a particle size for the metallic powder from receiver signals generated by the receiver.

2. A sensor according to claim 1, wherein the analyser is arranged to determine a particle size from a change in losses within the sensor due to the introduction of the sample into the microwave cavity or waveguide and/or magnetisation of the sample, as driven by the magnetic field.

3. A sensor according to claim 1, wherein the analyser is arranged to determine from the receiver signals a perturbation of the magnetic field generated in the cavity or waveguide when the sample is present from a reference magnetic field and determine the particle size from the perturbation.

4. A sensor according to claim 3, wherein the reference magnetic field is a magnetic field generated in the cavity or waveguide in the absence of metallic powder.

5. A sensor according to claim 3, wherein the reference magnetic field is a magnetic field generated when a reference metallic powder is present in the cavity or waveguide.

6. A sensor according to claim 3, wherein the perturbation is determined by measuring a power of receiver signals.

7. A sensor according to claim 6, wherein the perturbation is determined by measuring a phase of the receiver signals.

8. A sensor according to claim 3, wherein the perturbation comprises a change in a Q-factor of the microwave cavity or waveguide.

9. A sensor according to claim 3, wherein the perturbation comprises a change in a resonant frequency of the microwave cavity.

10. A sensor according to claim 1 comprising a controller for controlling the microwave source such that a transmission mode of the microwaves in the microwave cavity or waveguide satisfy the condition that an electric field is substantially zero at the sample and/or that an energy integrated across the sample for the electric field is at least two orders of magnitude below that for the magnetic field.

11. A sensor according to claim 10, wherein the sample insertion point has a required geometry such that one or more transmission modes of the microwaves satisfy the above condition.

12. A sensor according to claim 10, wherein the controller is arranged to control the microwave source such that a plurality of transmission modes are generated in the microwave cavity or waveguide and the analyser is arranged to determine particle sizes for the sample for each transmission mode.

13.-20. (canceled)

21. A sensor according to claim 1, comprising a temperature regulator for regulating a temperature of the microwave cavity or waveguide.

22. A sensor according to claim 21, wherein the temperature regulator comprises a heater and/or cooler for heating and/or cooling the microwave cavity or waveguide.

23. A sensor according to claim 22, wherein the temperature regulator comprises a temperature sensor for measuring a temperature of the microwave cavity or waveguide, the temperature regulator arranged to heat or cool the microwave cavity or waveguide based upon the temperature sensor to ensure that the temperature of the microwave cavity or waveguide is within a predefined temperature range.

24. A method of determining a particle size for metallic powder comprising inserting a sample of the metallic powder into a microwave cavity or waveguide, generating microwaves within the microwave cavity or waveguide, detecting microwaves generated within the cavity or waveguide and determining a particle size for the metallic powder from the detected microwaves.

25.-38. (canceled)

39. An analyser for determining a particle size for of metallic powder, the analyser comprising a processor arranged to receive a signal indicative of a detected microwave power in a microwave cavity or waveguide containing a sample of the metallic powder, determine from the detected signal a change in the microwave field generated in the microwave cavity or waveguide when the sample is present compared to a reference condition, and determine a particle size for the metallic powder from the change.

40. An analyser according to claim 39, wherein the reference condition is a power loss, phase and/or resonant frequency of the microwaves in the microwave cavity or waveguide when no metallic powder is present.

41. An analyser according to claim 39, wherein the reference condition is a power loss phase and/or resonant frequency of the microwaves in the microwave cavity or waveguide when a reference metallic powder is present.

42.-45. (canceled)

46. An additive manufacturing apparatus, which builds workpieces by solidification of metallic powder in a layer-by-layer manner, comprising a sensor according to claim 1.

47. (canceled)
